(19) United States
(12) Patent Application Publication
(10) Pub. No.: US 2011/0133581 A1
(43) Pub. Date: Jun. 9, 2011

(54) CONCENTRATED WINDING TYPE DRIVING MOTOR FOR VEHICLE

(75) Inventor: Jae Won Ha, Yongin (KR)

(73) Assignees: HYUNDAI MOTOR COMPANY, Seoul (KR); KIA MOTORS CORPORATION, Seoul (KR)

(21) Appl. No.: 12/764,471

(22) Filed: Apr. 21, 2010

(30) Foreign Application Priority Data
Dec. 3, 2009 (KR) 10-2009-0118882

(51) Int. Cl. H02K 3/50

(52) U.S. Cl. 310/71

(57) ABSTRACT

Disclosed herein is a concentrated winding type coil connecting structure of a driving motor for a hybrid vehicle. A protrusion protrudes upwards (the axial direction of the motor) from each of U-/V-/W-/N-phase conducting plates concentrically inserted into receiving grooves of a conductor holder, and a bent part is bent from the upper end of the protrusion in a radial direction of the motor, and a curved groove is formed in an end of the bent part to surround the circumferential surface of each of the coils, so that a connector integrally having the protrusion, the bent part and the groove allows each conducting plate and the coil to be firmly joined to each other, thus maintaining a strong force of connection between the conducting plate and the coil, and providing high workability and durability.

### CROSS-REFERENCE TO RELATED APPLICATION

This application claims under 35 U.S.C. §119(a) the benefit of Korean Patent Application No. 10-2009-0118882 filed Dec. 3, 2009, the entire contents of which are incorporated herein by reference.

### BACKGROUND

(a) Technical Field

The present disclosure relates to a concentrated winding type coil of a driving motor for a hybrid vehicle. In particular preferred embodiments, the present invention relates to a concentrated-winding type coil of a driving motor for a hybrid vehicle, that maintains a firm connection between a conducting plate and a coil of the motor.

(b) Background Art

A distributed winding type motor does not require a coil connecting structure, whereas a concentrated winding type motor requires a coil connecting structure. In a typical concentrated winding type motor, a toroidal coil is used as a conductor for connecting coils, and the conductor is formed by bending. Further, the conductor is axially layered outside slots in a circular fashion. In order to connect the conductor to the coil of each of the slots, the ends thereof are fused and welded using an additional connecting part.

FIG. 1 is a schematic view illustrating a portion of a conventional concentrated winding type motor. The conventional concentrated winding type motor includes main terminal parts 100 which protrude inwards in a radial direction, and three-phase power supply terminal parts 110 which protrude outwards in a radial direction.

Each of the main terminal parts 100 has a trapezoidal shape and comprises a U phase 100U, a V phase 100V, and a W phase 100W which are arranged sequentially and side by side in a circumferential direction at regular intervals.

Further, the power supply terminal parts 110 and lead frames 120 are installed to correspond to the respective phases of the main terminal parts 100.

As shown in FIG. 1, the lead frames 120 are superposed on each other and are attached to each other by resin 130 that is applied to the lead frames at a regular interval.

Such a concentrated winding type motor, however, has a problem of spatial limitation when it is installed in a vehicle. Also, the optimal vibration and temperature conditions thereof are harder to be achieved than those of a general motor, and therefore it is difficult to realize firm connection in a conventional structure.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a concentrated winding type coil connecting structure of a driving motor for a hybrid vehicle, in which a protrusion protrudes upwards (the axial direction of the motor) from each of U-/V-/W-/N-phase conducting plates concentrically inserted into receiving grooves of a conductor holder, and a bent part is preferably bent from the upper end of the protrusion in a radial direction of the motor, and a curved groove is formed in an end of the bent part to surround the circumferential surface of each of the coils, so that a connector integrally having the protrusion, the bent part and the groove allows each conducting plate and the coil to be firmly joined to each other, thus maintaining a strong force of connection between the conducting plate and the coil.

In a preferred embodiment, the coils may pass through the conductor holder and protrude upwards in a vertical direction, and the upper ends of the coils may be suitably positioned in “the same diameter” and at “the same height” along a concentric circle, thus allowing the coils to be easily fusion welded to connectors of conducting plates.

As described above, a concentrated winding type coil connecting structure of a driving motor for a hybrid vehicle according to the present invention provides the following effects.

First, U-/V-/W-/N-phase conducting plates are concentrically arranged outside coil winding parts, thus preventing interference between connectors which connect coils to the conducting plates, in comparison with the arrangement wherein the conducting plates are positioned inside the coil winding parts.

Second, a groove of each connector is fusion welded to the corresponding coil in such a way as to surround the circumferential surface of the coil, thus maximizing a welding area, therefore keeping the force of connection between the coil and a conducting plate strong.

Third, after coils are taken out from corresponding coil winding parts and fixedly inserted into corresponding insert slots of a bobbin, the coils extend along a surface of the bobbin and protrude upwards in a vertical direction through the through holes of a conductor holder, thus improving the durability of the coils, and the upper ends of the coils are arranged in the same radius and at the same height in the circumferential direction of a motor, thus allowing grooves of the connectors and the upper ends of the coils to be easily fusion welded to each other, therefore suitably improving welding workability.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a schematic view illustrating a portion of a conventional concentrated winding type driving motor for a vehicle;

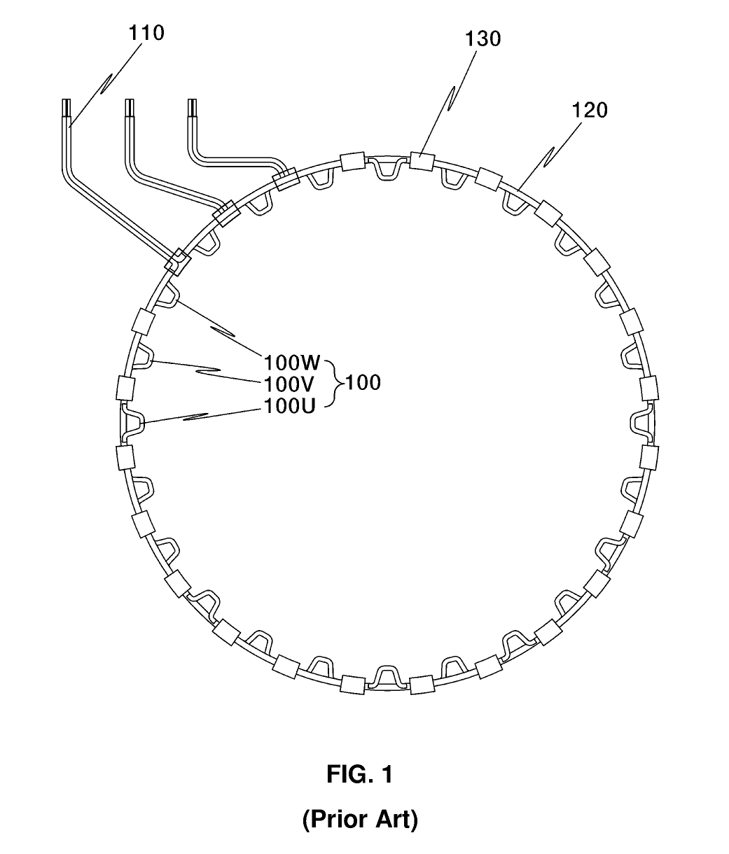

FIG. 2 is a front view illustrating a concentrated winding type driving motor for a vehicle according to an embodiment of the present invention;

FIG. 3 is an enlarged view illustrating portion A encircled in FIG. 2;

FIG. 4 is a sectional view taken along line X-X of FIG. 2;

FIG. 5 is a perspective view illustrating the connection of coils and conducting plates according to the embodiment of the present invention; and

FIG. 6 is a perspective view seen from direction B of FIG. 5.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In a first aspect, the present invention features a concentrated winding type driving motor for a vehicle, comprising a conductor holder provided with a plurality of receiving grooves concentrically formed at a predetermined interval and provided with through holes at a predetermined interval, a plurality of conducting plates each of which is inserted into and secured to each of the receiving grooves, respectively, a plurality of coils each of which passes vertically through the through holes; and a plurality of connectors each of which is positioned in a radial direction of the conductor holder to connect one of the conducting plates with one of the coils, wherein one end portion of each of the connectors is bent in the circumferential direction of the conductor holder and extends downwardly to be in contact with one of the conducting plates, and wherein the other end portion of each of the connectors is bent to form a curved groove by which a portion of the circumferential surface of one of the coils is surrounded.

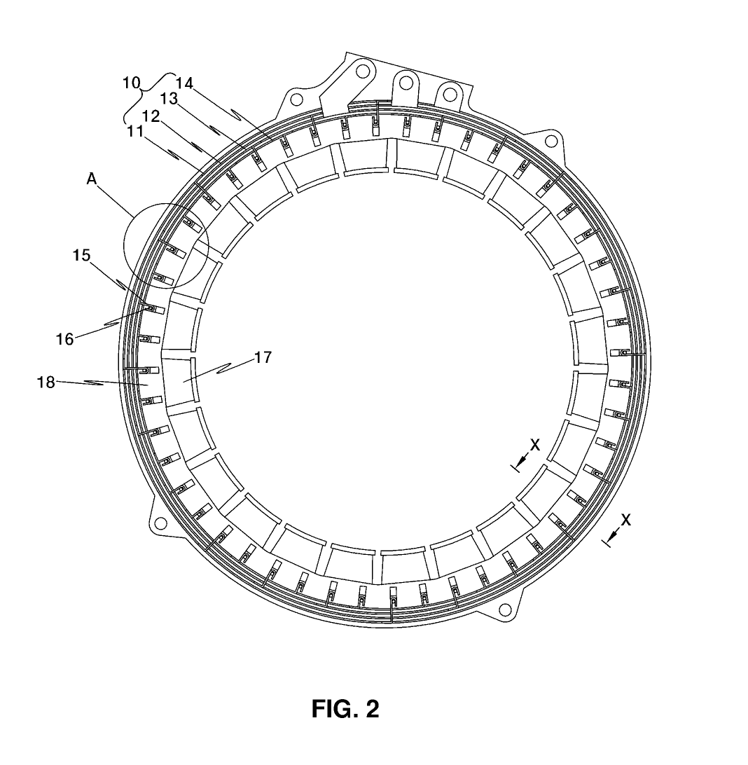

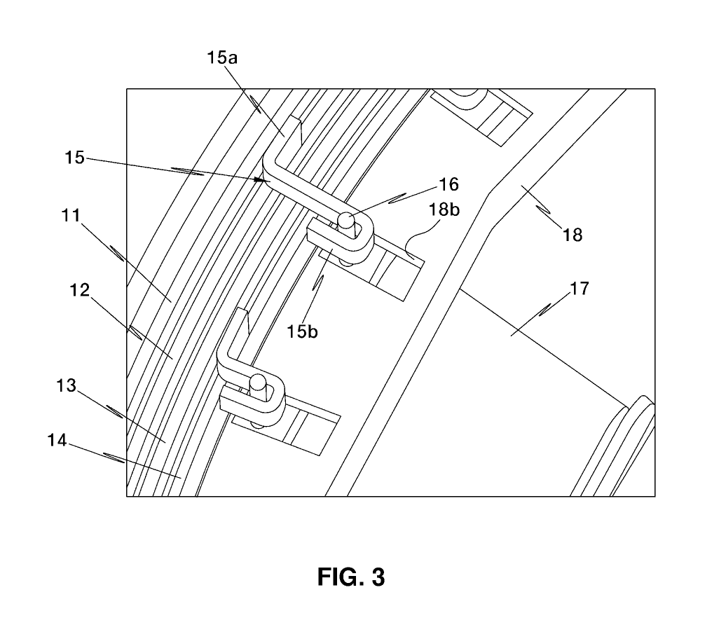

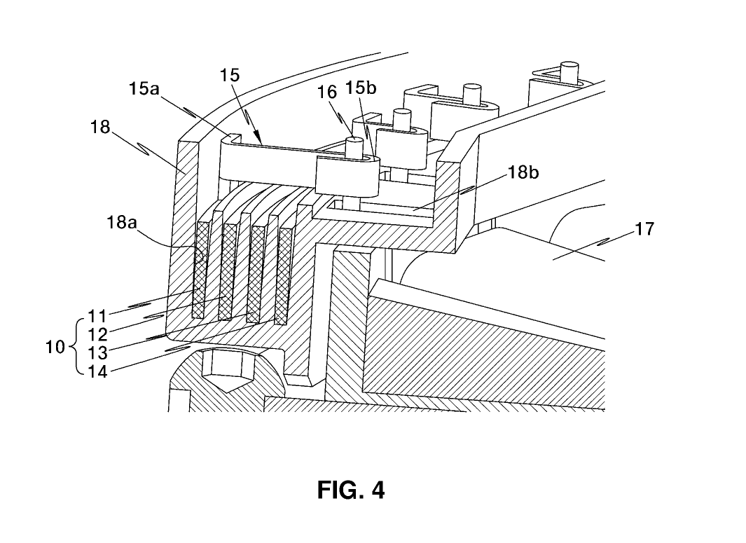

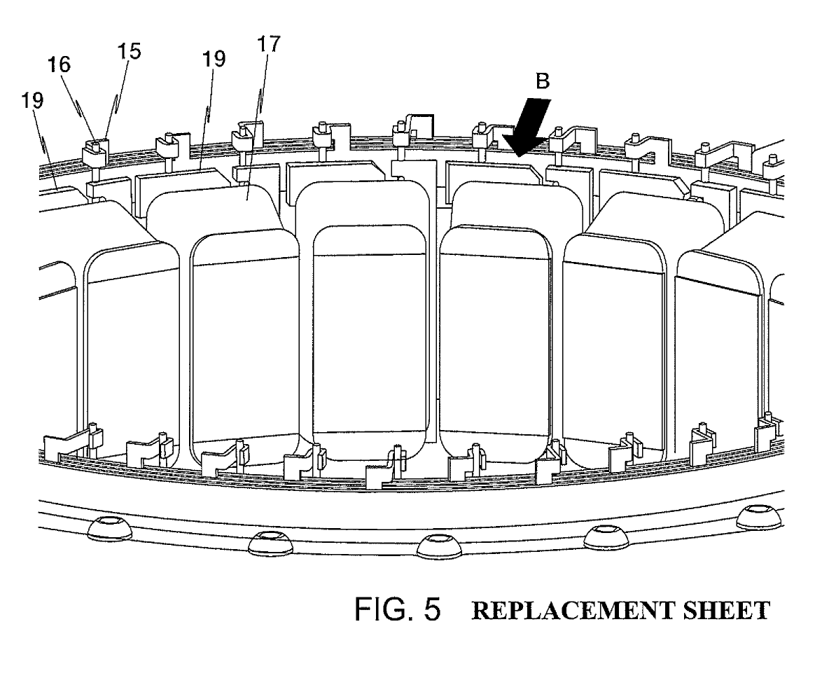

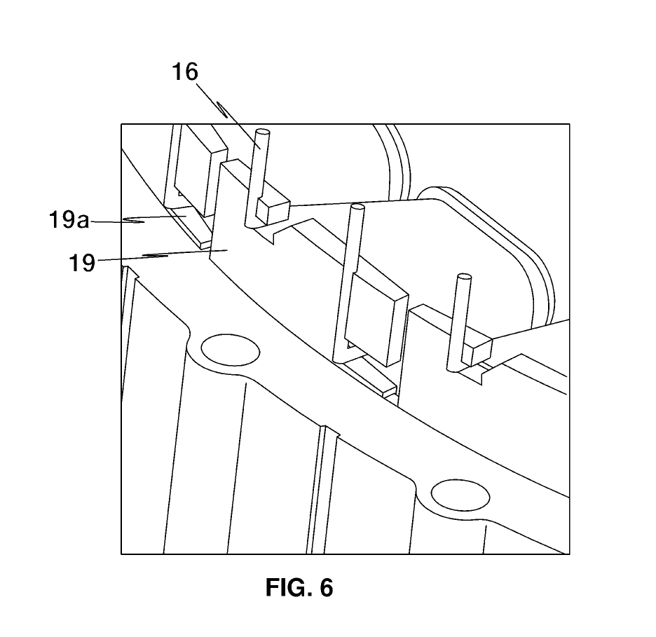

Hereinafter reference will now be made in detail to various embodiments of the present invention, examples of which are illustrated in FIGS. 2-6 and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

A concentrated winding type driving motor for a vehicle according to an embodiment of the present invention includes a conductor holder 18, conducting plates 10, coils 16, and connectors 15.

The conductor holder 18 is provided with a plurality of receiving grooves 18a and a plurality of through holes 18b. The receiving grooves 18a are concentrically formed therein at a predetermined interval and the through holes 18b are provided therein at a predetermined interval. Each of the conducting plates 10 is inserted into each of the receiving grooves 18a. Each of the coils passes vertically through the through holes. Each of the connectors is positioned in a radial direction of the conductor holder to connect one of the conducting plates with one of the coils. One end portion of each of the connectors is bent in a circumferential direction of the conductor holder and extends downwardly to form a protrusion 15a contacting one of the conducting plates. The other end portion of each of the connectors is bent to form a curved groove 15b. A portion of the circumferential surface of one of the coils is surrounded by the curved groove 15b.

Preferably, the conducting plates 10 may be consisted of a W-phase conducting plate 11, a V-phase conducting plate 12, a U-phase conducting plate 13, and an N-phase conducting plate 14. For example, the N-phase conducting plate 14, which serves as a neutral point, may be inserted into the innermost receiving groove 18a, the U-phase/V-phase/W-phase conducting plates 13, 12, and 11 may be sequentially inserted. That is, the W-phase conducting plate 11 may be arranged at the outermost position, the V-phase conducting plate 12 may be arranged right inside the W-phase conducting plate 11, the U-phase conducting plate 13 may be arranged inside the V-phase conducting plate 12, and the N-phase conducting plate 14 may be arranged at the innermost position. The four conducting plates 10 are concentrically installed at one or more intervals. Suitably, the conducting plates 14, 13, 12, and 11 may be secured by, e.g., epoxy molding.

Coil winding parts 17 are provided in the driving motor in the circumferential direction thereof. Each coil winding part 17 includes the coil 16 wound in a winding slot.

The conducting plate 10 and the receiving grooves 18a are arranged outside the coil winding parts 17 in such a way as to be concentric with the coil winding parts 17. Such an arrangement can avoid interference between the conducting plate 10 and the coil 16, in comparison with the arrangement in which the conducting plate 10 is positioned inside the coil winding parts 17.

The conductor holder 18 is made of a plastic material to have non-conductivity, and increases connecting force with the conductor made of the copper material.

Further, through holes 18b are formed between the receiving grooves 18a of the conductor holder 18 and the coil winding parts 17. The coil 16 of each coil winding part 17 passes through the conductor holder 18 in a vertical direction (the axial direction of the motor) via the through hole 18b.

Here, after an end of the coil 16 wound in each coil winding part 17 is inserted into and secured to an associated insert slot 19a of a bobbin 19, the coil 16 is bent upwards in a vertical direction along a surface of the bobbin 19, thus improving the durability of the coil 16.

Further, the coils 16 have the same radius with reference to the radial direction of the motor in the circumferential direction thereof, and the upper ends of the coils 16 are positioned at the same height, thus allowing a fusion welding operation to be performed most easily.

Here, in order to connect the U-phase/V-phase/W-phase/N-phase conducting plates 13, 12, 11 and 14 to the coils 16, a plurality of connectors 15 are provided on the conducting plate 10 at one or more predetermined intervals in such a way as to be bent in a radial direction.

Each of the connectors 15 includes a protrusion 15a which protrudes axially from the corresponding conducting plate 10, a bent part 15b which is bent radially from an end of the protrusion 15a, and a “U”-shaped groove 15c which is defined in an end of the bent part 15b.

All of the protrusion 15a, the bent part 15b and the groove 15c protrude from the conducting plate 10 by a predetermined length in the axial direction of the motor, thus connecting the conducting plate 10 with an associated coil 16.

The position at which the protrusion 15a is attached to the conducting plate 10 varies. That is, the protrusion 15a of a first connector 15 can be attached to the plate 11, the protrusion 15a of a second connector 15 can be attached to the plate 12, the protrusion 15a of a third connector 15 can be attached to the plate 13, and the protrusion 15a of a fourth connector 15 can be attached to the plate 14. According to the attachment position, the length of the bent part 15b varies.

The upper end of each coil 16 passes through the interior of the groove 15c. The circumferential surface of the upper end of the coil 16 is surrounded by the inner surface of the “U”-shaped groove 15c and may be joined to the inner surface of the groove 15c by, e.g., fusion welding.

After the conducting plate 10 and the coils 16 are attached to each other, the space of the through hole 18b except for the space occupied by the coils 16 and a gap between the conducting plate 10 and the receiving grooves 18a are molded using epoxy, so that the coils 16 are secured to the conductor holder 18 and the conducting plate 10 is secured to the conductor holder 18.

As described above, the U-phase/V-phase/W-phase/N-phase conducting plates are concentrically arranged outside the coil winding parts 17. This arrangement significantly prevents interference between the connectors 15, compared to the arrangement wherein the conducting plates are arranged inside the coil winding parts 17.

As the respective protrusions 15a are attached to respective phase conducting plates, and the respective grooves 15c surround the circumferential surface of the respective coils 16 to be securely joined thereto, connection between the coils 16 and the conducting plate 10 can be firmly maintained.

In addition, as each of the coils 16 is taken out from the corresponding coil winding part 17 and is fixedly inserted into the corresponding insert slot 19a of the bobbin 19, and each of the coils 16 then extends along a surface of the bobbin 19 and protrudes upwards through the corresponding through hole 18b, the durability of the coils 16 can be improved.

Further, as the coils 16 are positioned so that the lengths between the respective coils and the center of the motor are identical and the heights of the respective coils are identical, joining the upper ends of the coils 16 to the grooves 15c can be facilitated.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A concentrated winding type driving motor for a vehicle, comprising:
a conductor holder provided with a plurality of receiving grooves concentrically formed at a predetermined interval and provided with through holes at a predetermined interval;
a plurality of conducting plates each of which is inserted into and secured to each of the receiving grooves, respectively;
a plurality of coils each of which passes vertically through the through holes; and
a plurality of connectors each of which is positioned in a radial direction of the conductor holder to connect one of the conducting plates with one of the coils,
wherein one end portion of each of the connectors is bent in the circumferential direction of the conductor holder and extends downwardly to be in contact with one of the conducting plates, and
wherein the other end portion of each of the connectors is bent to form a curved groove by which a portion of the circumferential surface of one of the coils is surrounded.

2. The concentrated winding type driving motor of claim 1, wherein each of the coils comes out from a coil winding part provided in the motor, is inserted into and secured to an insert slot of a bobbin provided in the motor, and extends to pass through the through holes of the conductor holder.

3. The concentrated winding type driving motor of claim 1, each of the coils is fixed to the curved groove of the connector by fusion welding.

4. The concentrated winding type driving motor of claim 1, wherein the lengths between the respective coils and the center of the motor are identical and the heights of the respective coils are identical.

5. The concentrated winding type driving motor of claim 1, wherein the conducing plates are U-/V-/W-/N-phase conducting plates.
